(19) United States
(12) Patent Application Publication
(10) Pub. No.: US 2012/0140882 A1
(43) Pub. Date: Jun. 7, 2012

(54) RADIOGRAPHIC SYSTEM

(75) Inventor: Naoto Iwakiri, Kanagawa (JP)

(73) Assignee: FUJIFILM Corporation, Tokyo (JP)

(21) Appl. No.: 13/302,112

(22) Filed: Nov. 22, 2011

(30) Foreign Application Priority Data
Dec. 7, 2010 (JP) 2010-273068

(51) Int. Cl. G01N 23/04

(52) U.S. Cl. 378/62

(57) ABSTRACT

A radiographic system includes: a first grating; a second grating having a period that substantially coincides with a pattern period of a radiological image formed by radiation having passed through the first grating; a radiological image detector that detects the radiological image masked by the second grating and outputs image data of the detected radiological image, and a control unit that performs a switching between a first mode in which a plurality of imaging is performed with the second grating being positioned at relative positions having different phases with regard to the radiological image and a second mode in which the radiological image detector is driven without radiation exposure. The control unit repeatedly drives the radiological image detector in the second mode until the radiological image detector is in a steady state and shifts to the first mode after the radiological image detector is in the steady state.

### CROSS-REFERENCE TO RELATED APPLICATIONS

This application is based on and claims priority under 35 USC 119 from Japanese Patent Application No. 2010-273068 filed on Dec. 7, 2010, the entire content of which is incorporated herein by reference.

### BACKGROUND

1. Technical Field

The invention relates to a radiographic system.

2. Related Art

Since X-ray attenuates depending on an atomic number of an element configuring a material and a density and a thickness of the material, it is used as a probe for seeing through an inside of a photographic subject. An imaging using the X-ray is widely spread in fields of medical diagnosis, nondestructive inspection and the like.

In a general X-ray imaging system, a photographic subject is arranged between an X-ray source that irradiates the X-ray and an X-ray image detector that detects an X-ray image, and a transmission image of the photographic subject is captured. In this case, the X-ray irradiated from the X-ray source toward the X-ray image detector is subject to the quantity attenuation (absorption) depending on differences of the material properties (for example, atomic numbers, densities and thickness) existing on a path to the X-ray image detector and is then incident onto the X-ray image detector. As a result, an X-ray transmission image of the photographic subject is detected and captured by the X-ray image detector. As the X-ray image detector, a flat panel detector (FPD) that uses a semiconductor circuit is widely used, in addition to a combination of an X-ray intensifying screen and a film and a photostimulable phosphor (accumulative phosphor).

However, the smaller the atomic number of the element configuring material, the X-ray absorption ability is reduced. Accordingly, for the soft biological tissue or soft material, a difference of the X-ray absorption abilities is small and thus it is not possible to acquire the contrast of an image that is enough for the X-ray transmission image. For example, the cartilaginous part and joint fluid configuring an articulation of the body are mostly comprised of water. Thus, since a difference of the X-ray absorption amounts thereof is small, it is difficult to obtain the contrast of an image. Up to date, the soft tissue can be imaged by using the MRI (Magnetic Resonance Imaging). However, it takes several tens of minutes to perform the imaging and the resolution of the image is low such as about 1 mm. Hence, it is difficult to use the MRI in a regular physical examination such as medical checkup due to the cost-effectiveness.

Regarding the above problems, instead of the intensity change of the X-ray by the photographic subject, a research on an X-ray phase imaging of obtaining an image (hereinafter, referred to as a phase contrast image) based on a phase change (refraction angle change) of the X-ray by the photographic subject has been actively carried out in recent years. In general, it has been known that when the X-ray is incident onto an object, the phase of the X-ray, rather than the intensity of the X-ray, shows the higher interaction. Accordingly, in the X-ray phase imaging of using the phase difference, it is possible to obtain a high contrast image even for a weak absorption material having a low X-ray absorption ability. Up to date, regarding the X-ray phase imaging, it has been possible to perform the imaging by generating the X-ray having a wavelength and a phase with a large-scaled synchrotron radiation facility (for example, SPring-8) using an accelerator, and the like. However, since the facility is too huge, it cannot be used in a usual hospital. As the X-ray phase imaging to solve the above problem, an X-ray imaging system has been recently suggested which uses an X-ray Talbot interferometer having two transmission diffraction gratings (phase type grating and absorption type grating) and an X-ray image detector (for example, refer to Patent Document 1 (JP-A-2008-200360)).

The X-ray Talbot interferometer includes a first diffraction grating (phase type grating or absorption type grating) that is arranged at a rear side of a photographic subject, a second diffraction grating (absorption type grating) that is arranged downstream at a specific distance (Talbot interference distance) determined by a grating pitch of the first diffraction grating and an X-ray wavelength, and an X-ray image detector that is arranged at a rear side of the second diffraction grating. The Talbot interference distance is a distance in which the X-ray having passed through the first diffraction grating forms a self-image by the Talbot interference effect. The self-image is modulated by the interaction (phase change) of the photographic subject, which is arranged between the X-ray source and the first diffraction grating, and the X-ray.

According to the fringe scanning method, a plurality of imaging is performed while the second diffraction grating is translation-moved with respect to the first diffraction grating in a direction, which is substantially parallel with a plane of the first diffraction grating and is substantially perpendicular to a grating direction (strip band direction) of the first diffraction grating, with a scanning pitch that is obtained by equally partitioning the grating pitch. Then, an angle distribution (differential image of a phase shift) of the X-ray refracted at the photographic subject is acquired from changes of signal values of respective pixels obtained in the X-ray image detector. Based on the acquired angle distribution, it is possible to obtain a phase contrast image of the photographic subject. According to the X-ray phase imaging, as described above, it is possible to capture an image of the cartilage or soft tissue that cannot be seen in the X-ray absorption image. Thus, it is possible to rapidly and easily diagnose the knee osteoarthritis that about a half of the aged (about 30 million persons) are regarded to have, the arthritic disease such as meniscus injury due to sports disorders, the rheumatism, the Achilles tendon injury, the disc hernia and the soft tissue such as breast tumor mass by the X-ray. Hence, it is expected that it is possible to contribute to the early diagnosis and the early treatment of the potential patient and the reduction of the medical care cost.

The FPD includes photoelectric conversion elements each of which directly or indirectly converts the X-ray into charges and is provided to each pixel and a readout circuit that reads out the charges generated in the respective pixels and converts and outputs the same into digital image data. A signal value of each pixel configuring the image data includes an offset component that is caused due to the dark current of the pixel or temperature drift of the readout circuit. In general, an offset correction is performed to remove the offset component. The radiographic system disclosed in Patent Document 1 also performs the offset correction for the image data. Patent Document 1 does not specifically disclose the offset correction. However, according to the typical offset correction, before the imaging, the respective pixels of the FPD are read out without irradiating the X-ray, so that data for correction is obtained. The data for correction reflects the offset that is caused due to the dark current of the pixel or temperature drift of the readout circuit. The offset correction of image data acquired by the imaging is performed by subtracting the data for correction from the image data.

Here, the offset that is caused due to the dark current of the pixel or temperature drift of the readout circuit depends on the temperature of the pixel or readout circuit. According to the fringe scanning method, as described above, a plurality of imaging is continuously performed while the second grating is translation-moved with a predetermined scanning pitch, the temperature of the pixel or readout circuit is apt to increase and an offset variation may be caused during the imaging. The phase contrast image is generated based on a refraction angle distribution of the X-ray that is calculated from changes of the signal values of the respective pixels obtained by the plurality of imaging. At this time, the position deviation of the X-ray caused due to the change of the phase shift/refractive index of the X-ray, which is caused when the X-ray penetrates the photographic subject, is slight such as about 1 μm. Also, as described above, the plurality of imaging is performed while the second grating is translation-moved with a predetermined scanning pitch and the phase contrast image is reconstructed by the calculation from the slight changes of the signal values of the respective pixels obtained in the X-ray image detector. Therefore, the offset variation during the imaging causes a calculation error when calculating the refraction angle distribution. The calculation error lowers the contrast or resolution of the phase contrast image and causes the artifact in which the moiré fringe is insufficiently removed or unstable non-uniform is generated, so that the diagnosis and examination accuracies may be remarkably deteriorated. Like this, the influence of the offset variation on the phase contrast image is much higher, compared to the typical still image of the X-ray or moving picture imaging in which images are not reconstructed by calculation from the slight changes of the images.

Also, even compared to the technique of performing a plurality of imaging in which the images of the photographic subject are largely changed while changing the incident angle of the X-ray onto the photographic subject and then reconstructing the images, such as CT or Tomosynthesis, the above influence of the offset variation on the phase contrast image is very high. The reason is as follows. In the phase contrast image, the slight position deviation of the X-ray such as 1 μm, which is caused due to the phase shift/refractive index change of the X-ray, is captured as the moiré superposition on the photographic subject image while translation-moving the second grating without changing the incident angle of the X-ray onto the photographic subject. However, the image itself of the photographic subject is little changed, so that the phase contrast images are reconstructed from the slight image changes between the images. Accordingly, even compared to the image capturing of performing the reconstruction, such as CT or Tomosynthesis of calculating the reconstruction images from the plurality of images in which the images of the photographic subject are largely changed because the incident angle of the X-ray is changed, the influence of the slight image change is high in the phase contrast image. Also in an energy subtraction imaging technique of reconstructing an energy absorption distribution from photographic subject images of different energies at the same X-ray incident angle and separating soft tissue, bone tissue and the like, the imaging energies are different in the energy subtraction images, so that the photographic subject contrasts are largely changed between the images. Thus, the offset variation highly influences the phase contrast image.

In order to remove the influence of the offset variation during the imaging, it may be considered to acquire the data for correction every imaging. In this case, the time that is required to complete the plurality of imaging is prolonged. When the photographic subject is a biological body, the photographic subject is apt to move during the imaging. In particular, when performing a plurality of imaging with respect to the X-ray phase imaging, the imaging should be performed in a short time because a patient cannot typically keep still for a long time due to the diseases and is thus apt to move. When the photographic subject moves during the imaging, the artifact is generated in the phase contrast image and the contrast and the resolution are considerably deteriorated.

### SUMMARY

An object of the invention is to sufficiently suppress an offset variation during an imaging and to thus improve a quality of a phase contrast image.

According to an aspect of the invention, a radiographic system includes: a first grating; a second grating having a period that substantially coincides with a pattern period of a radiological image formed by radiation having passed through the first grating; a radiological image detector that detects the radiological image masked by the second grating and outputs image data of the detected radiological image, and a control unit that performs a switching between a first mode in which a plurality of imaging is performed with the second grating being positioned at relative positions having different phases with regard to the radiological image and a second mode in which the radiological image detector is driven without radiation exposure. The control unit repeatedly drives the radiological image detector in the second mode until the radiological image detector is in a steady state and shifts to the first mode after the radiological image detector is in the steady state.

With the configuration discussed above, the radiological image detector is repeatedly driven in the second mode, so that the radiological image detector is put in the steady state. After the radiological image detector is in the steady state, the radiographic system shifts to the first mode, so that a plurality of imaging is performed. In the steady state, the temperature variation of the radiological image detector and the offset variation depending on the temperature are suppressed. Thus, it is possible to prevent the signal values of the respective pixels of the image data, which is output from the radiological image detector, from being changed due to the offset variation, during the plurality of imaging in the first mode, and to securely acquire the changes of the signal values of the respective pixels based on the displacement of the second grating. Thereby, it is possible to improve the quality of the phase contrast image.

### BRIEF DESCRIPTION OF THE DRAWINGS

FIG. 1 is a pictorial view showing an example of a configuration of a radiographic system for illustrating an illustrative embodiment of the invention.

FIG. 2 is a control block diagram of the radiographic system of FIG. 1.

FIG. 3 is a pictorial view showing a configuration of a radiological image detector of the radiographic system of FIG. 1.

FIG. 4 is a perspective view of an imaging unit of the radiographic system of FIG. 1.

FIG. 5 is a side view of the imaging unit of the radiographic system of FIG. 1.

FIGS. 6A to 6C are pictorial views each showing a mechanism for changing a period of a moiré fringe resulting from superposition of first and second gratings.

FIG. 7 is a pictorial view for illustrating refraction of radiation by a photographic subject.

FIG. 8 is a pictorial view for illustrating a fringe scanning method.

FIG. 9 is a graph showing pixel signals of a radiological image detector in accordance with the fringe scanning.

FIG. 10 is a flowchart showing an imaging process in the radiographic system of FIG. 1.

FIG. 11 is a view for illustrating a method of determining a steady state of a radiological image detector in another example of a radiographic system for illustrating an illustrative embodiment of the invention.

FIG. 12 is a pictorial view showing another example of a configuration of a radiographic system for illustrating an illustrative embodiment of the invention.

FIG. 13 is a pictorial view showing a configuration of a modified embodiment of the radiographic system of FIG. 10.

FIG. 14 is a pictorial view showing another example of a configuration of a radiographic system for illustrating an illustrative embodiment of the invention.

FIG. 15 is a block diagram showing a configuration of a calculation processing unit in accordance with another example of a radiographic system for illustrating an illustrative embodiment of the invention.

FIG. 16 is a graph showing pixel signals of a radiological image detector for illustrating a process in the calculation unit of the radiographic system shown in FIG. 15.

### DETAILED DESCRIPTION

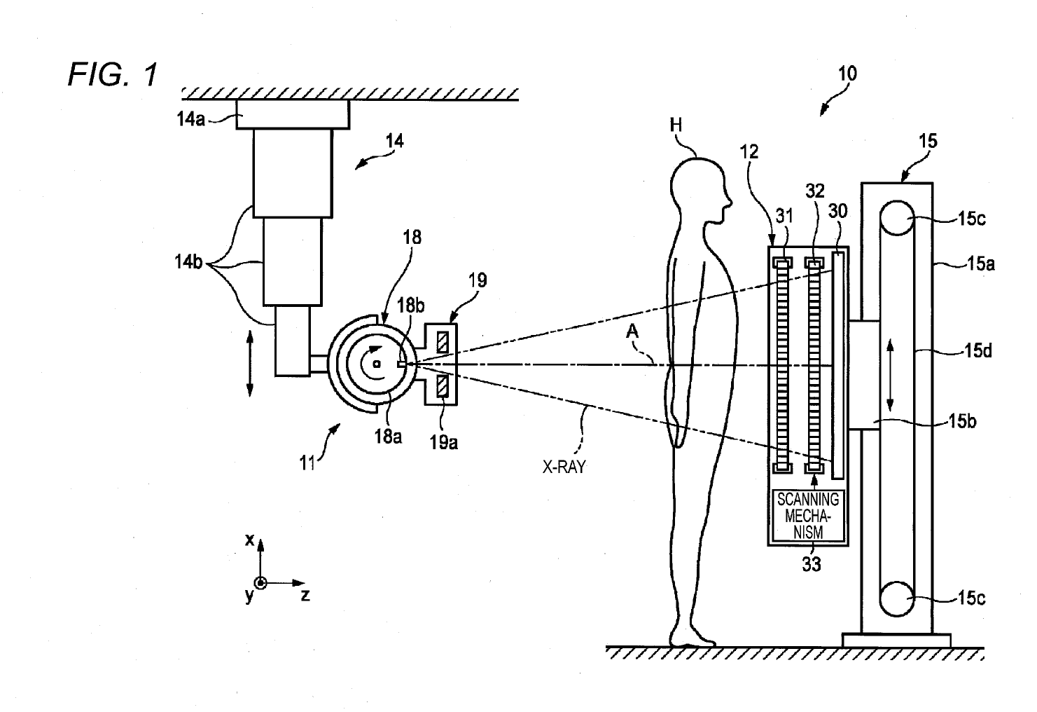

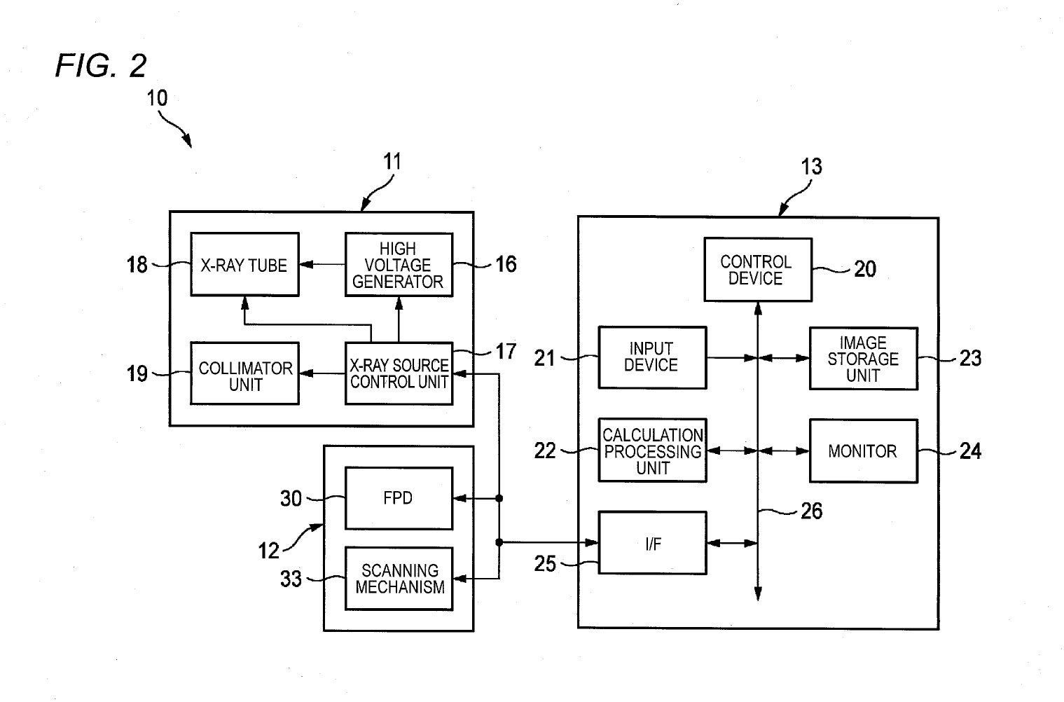

FIG. 1 shows an example of a configuration of a radiographic system for illustrating an illustrative embodiment of the invention and FIG. 2 is a control block diagram of the radiographic system of FIG. 1.

An X-ray imaging system 10 is an X-ray diagnosis apparatus that performs an imaging for a photographic subject (patient) H while the patient stands, and includes an X-ray source 11 that X-radiates the photographic subject H, an imaging unit 12 that is opposed to the X-ray source 11, detects the X-ray having penetrated the photographic subject H from the X-ray source 11 and thus generates image data and a console 13 that controls an exposing operation of the X-ray source 11 and an imaging operation of the imaging unit 12 based on an operation of an operator, calculates the image data acquired by the imaging unit 12 and thus generates a phase contrast image.

The X-ray source 11 is held so that it can be moved in an upper-lower direction (x direction) by an X-ray source holding device 14 hanging from the ceiling. The imaging unit 12 is held that it can be moved in the upper-lower direction by an upright stand 15 mounted on the bottom.

The X-ray source 11 includes an X-ray tube 18 that generates the X-ray in response to a high voltage applied from a high voltage generator 16, based on control of an X-ray source control unit 17, and a collimator unit 19 having a moveable collimator 19a that limits an irradiation field so as to shield a part of the X-ray generated from the X-ray tube 18, which part does not contribute to an inspection area of the photographic subject H. The X-ray tube 18 is a rotary anode type that emits an electron beam from a filament (not shown) serving as an electron emission source (cathode) and collides the electron beam with a rotary anode 18a being rotating at predetermined speed, thereby generating the X-ray. A collision part of the electron beam of the rotary anode 18a is an X-ray focal point 18b.

The X-ray source holding device 14 includes a carriage unit 14a that is adapted to move in a horizontal direction (z direction) by a ceiling rail (not shown) mounted on the ceil and a plurality of strut units 14b that is connected in the upper-lower direction. The carriage unit 14a is provided with a motor (not shown) that expands and contracts the strut units 14b to change a position of the X-ray source 11 in the upper-lower direction.

The upright stand 15 includes a main body 15a that is mounted on the bottom and a holding unit 15b that holds the imaging unit 12 and is attached to the main body 15a so as to move in the upper-lower direction. The holding unit 15b is connected to an endless belt 15d that extends between two pulleys 16c spaced in the upper-lower direction, and is driven by a motor (not shown) that rotates the pulleys 15c. The driving of the motor is controlled by a control device 20 of the console 13 (which will be described later), based on a setting operation of the operator.

Also, the upright stand 15 is provided with a position sensor (not shown) such as potentiometer, which measures a moving amount of the pulleys 15c or endless belt 15d and thus detects a position of the imaging unit 12 in the upper-lower direction. The detected value of the position sensor is supplied to the X-ray source holding device 14 through a cable and the like. The X-ray source holding device 14 expands and contracts the struts units 14b, based on the detected value, and thus moves the X-ray source 11 to follow the vertical moving of the imaging unit 12.

The console 13 is provided with the control device 20 that includes a CPU, a ROM, a RAM and the like. The control device 20 is connected with an input device 21 with which the operator inputs an imaging instruction and an instruction content thereof, a calculation processing unit 22 that calculates the image data acquired by the imaging unit 12 and thus generates an X-ray image, a storage unit 23 that stores the X-ray image, a monitor 24 that displays the X-ray image and the like and an interface (I/F) 25 that is connected to the respective units of the X-ray imaging system 10, via a bus 26.

As the input device 21, a switch, a touch panel, a mouse, a keyboard and the like may be used, for example. By operating the input device 21, radiography conditions such as X-ray tube voltage, X-ray irradiation time and the like, an imaging timing and the like are input. The monitor 24 consists of a liquid crystal display and the like and displays letters such as radiography conditions and the X-ray image under control of the control device 20.

The imaging unit 12 has a flat panel detector (FPD) 30 that has a semiconductor circuit, and a first absorption type grating 31 and a second absorption type grating 32 that detect a phase change (angle change) of the X-ray by the photographic subject H and perform a phase imaging.

The FPD 30 has a detection surface that is arranged to be orthogonal to the optical axis A of the X-ray irradiated from the X-ray source 11. As specifically described in the below, the first and second absorption type gratings 31, 32 are arranged between the FPD 30 and the X-ray source 11.

Also, the imaging unit 12 is provided with a scanning mechanism 33 that translation-moves the second absorption type grating 32 in the upper-lower (x direction) and thus changes a relative position relation of the second absorption type grating 32 to the first absorption type grating 31. The scanning mechanism 33 consists of an actuator such as piezoelectric device, for example.

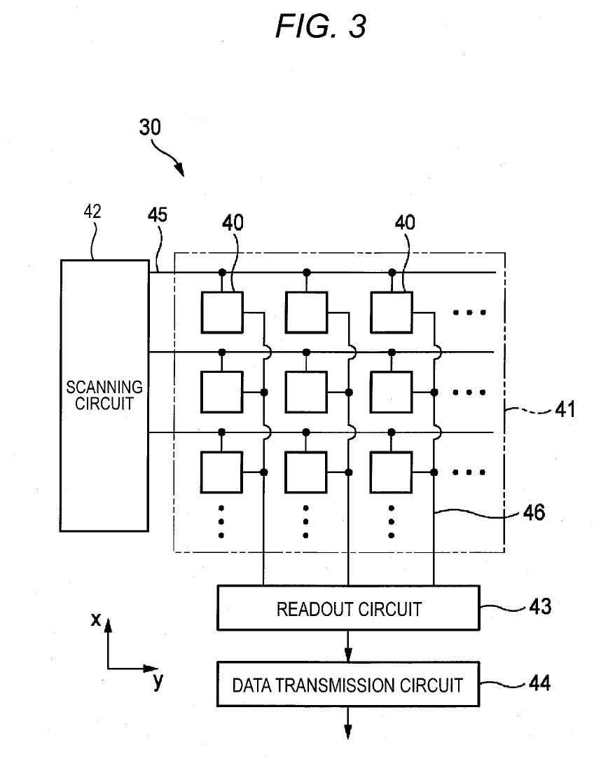

FIG. 3 shows a configuration of the radiological image detector that is included in the radiographic system of FIG. 1.

The FPD 30 serving as the radiological image detector includes an image receiving unit 41 having a plurality of pixels 40 that converts and accumulates the X-ray into charges and is two-dimensionally arranged in the xy directions on an active matrix substrate, a scanning circuit 42 that controls a timing of reading out the charges from the image receiving unit 41, a readout circuit 43 that reads out the charges accumulated in the respective pixels 40 and converts and stores the charges into image data and a data transmission circuit 44 that transmits the image data to the calculation processing unit 22 through the I/F 25 of the console 13. Also, the scanning circuit 42 and the respective pixels 40 are connected by scanning lines 45 in each of rows and the readout circuit 43 and the respective pixels 40 are connected by signal lines 46 in each of columns.

Each pixel 40 can be configured as a direct conversion type element that directly converts the X-ray into charges with a conversion layer (not shown) made of amorphous selenium and the like and accumulates the converted charges in a capacitor (not shown) connected to a lower electrode. Each pixel 40 is connected with a TFT (TFT: Thin Film Transistor) switch (not shown) and a gate electrode of the TFT switch is connected to the scanning line 45, a source electrode is connected to the capacitor and a drain electrode is connected to the signal line 46. When the TFT switch turns on by a driving pulse from the scanning circuit 42, the charges accumulated in the capacitor are read out to the signal line 46.

Meanwhile, each pixel 40 may be also configured as an indirect conversion type X-ray detection element that converts the X-ray into visible light with a scintillator (not shown) made of terbium-doped gadolinium oxysulfide (Gd₂O₂S:Tb), thallium-doped cesium iodide (CsI:Tl) and the like and then converts and accumulates the converted visible light into charges with a photodiode (not shown). Also, the X-ray image detector is not limited to the FPD based on the TFT panel. For example, a variety of X-ray image detectors based on a solid imaging device such as CCD sensor, CMOS sensor and the like may be also used.

The readout circuit 43 includes an integral amplification circuit, an A/D converter, a correction circuit and an image memory, which are not shown. The integral amplification circuit integrates and converts the charges output from the respective pixels 40 through the signal lines 46 into voltage signals (image signals) and inputs the same into the A/D converter. The A/D converter converts the input image signals into digital image data and inputs the same to the correction circuit. The correction circuit performs such as an offset correction, a gain correction and a linearity correction for the image data and stores the image data after the corrections in the image memory. Meanwhile, the correction process of the correction circuit may include a correction of an exposure amount and an exposure distribution (so-called shading) of the X-ray, a correction of a pattern noise (for example, a leak signal of the TFT switch) depending on control conditions (driving frequency, readout period and the like) of the FPD 30, and the like.

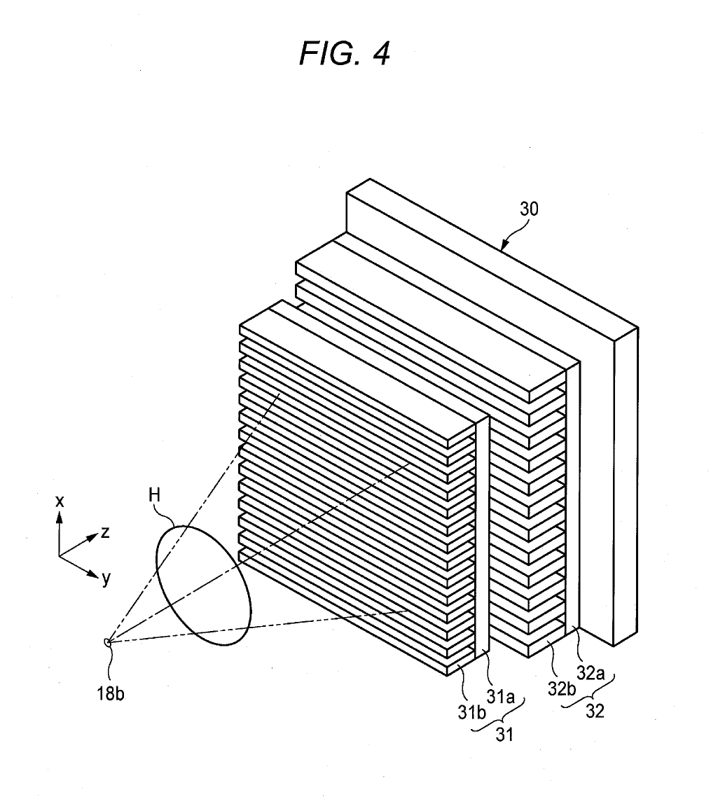

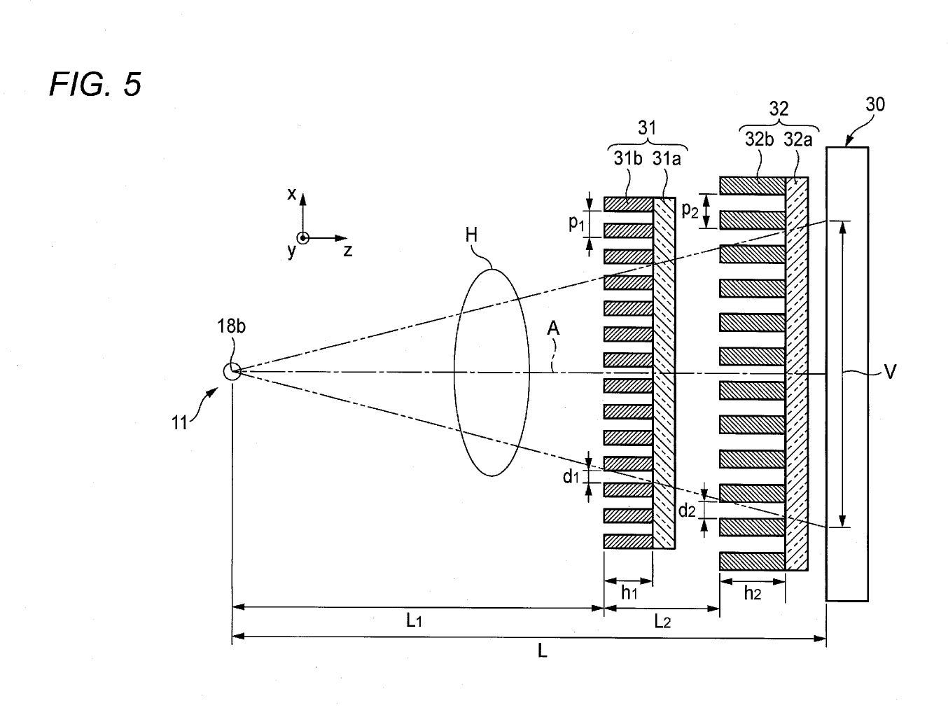

FIGS. 4 and 5 show the imaging unit of the radiographic system of FIG. 1.

The first absorption type grating 31 has a substrate 31a and a plurality of X-ray shield units 31b arranged on the substrate 31a. Likewise, the second absorption type grating 32 has a substrate 32a and a plurality of X-ray shield units 32b arranged on the substrate 32a. The substrates 31a, 32a are configured by radiolucent members through which the X-ray penetrates, such as glass.

The X-ray shield units 31b, 32b are configured by linear members extending in in-plane one direction (in the shown example, a y direction orthogonal to the x and z directions) orthogonal to the optical axis A of the X-ray irradiated from the X-ray source 11. As the materials of the respective X-ray shield units 31b, 32b, materials having excellent X-ray absorption ability are preferable. For example, the heavy metal such as gold, platinum and the like is preferable. The X-ray shield units 31b, 32b can be formed by the metal plating or deposition method.

The X-ray shield units 31b are arranged on the in-plane orthogonal to the optical axis A of the X-ray with a constant pitch p₁ and at a predetermined interval d₁ in the direction (x direction) orthogonal to the one direction. Likewise, the X-ray shield units 32b are arranged on the in-plane orthogonal to the optical axis A of the X-ray with a constant pitch p₂ and at a predetermined interval d₂ in the direction (x direction) orthogonal to the one direction. Since the first and second absorption type gratings 31, 32 provide the incident X-ray with an intensity difference, rather than the phase difference, they are also referred to as amplitude type gratings. In the meantime, the slit (area of the interval d₁ or d₂) may not be a void. For example, the void may be filled with X-ray low absorption material such as high molecule or light metal.

The first and second absorption type gratings 31, 32 are adapted to geometrically project the X-ray having passed through the slits, regardless of the Talbot interference effect. Specifically, the intervals d₁, d₂ are set to be sufficiently larger than a peak wavelength of the X-ray irradiated from the X-ray source 11, so that most of the X-ray included in the irradiated X-ray is enabled to pass through the slits while keeping the linearity thereof, without being diffracted in the slits. For example, when the rotary anode 18a is made of tungsten and the tube voltage is 50 kV, the peak wavelength of the X-ray is about 0.4 Å. In this case, when the intervals d₁, d₂ are set to be about 1 to 10 μm, most of the X-ray is geometrically projected in the slits without being diffracted.

Since the X-ray irradiated from the X-ray source 11 is a conical beam having the X-ray focal point 18b as an emitting point, rather than a parallel beam, a projection image (hereinafter, referred to as G1 image), which has passed through the first absorption type grating 31 and is projected, is enlarged in proportion to a distance from the X-ray focal point 18b. The grating pitch p₂ and the interval d₂ of the second absorption type grating 32 are determined so that the slits substantially coincide with a periodic pattern of bright parts of the G1 image at the position of the second absorption type grating 32. That is, when a distance from the X-ray focal point 18b to the first absorption type grating 31 is L₁ and a distance from the first absorption type grating 31 to the second absorption type grating 32 is L₂, the grating pitch p₂ and the interval d₂ are determined to satisfy following equations (1) and (2).

$$\begin{matrix}[ equation 1 ] & \\ {p}_{2} = \frac{{L}_{1} + {L}_{2}}{{L}_{1}} {p}_{1} & ( 1 ) \\ [ equation 2 ] & \\ {d}_{2} = \frac{{L}_{1} + {L}_{2}}{{L}_{1}} {d}_{1} & ( 2 )\end{matrix}$$

In the Talbot interferometer, the distance L₂ from the first absorption type grating 31 to the second absorption type grating 32 is restrained with a Talbot interference distance that is determined by a grating pitch of a first diffraction grating and an X-ray wavelength. However, in the imaging unit 12 of the X-ray imaging system 10 of this illustrative embodiment, since the first absorption type grating 31 projects the incident X-ray without diffracting the same and the G1 image of the first absorption type grating 31 is similarly obtained at all positions of the rear of the first absorption type grating 31, it is possible to set the distance L₂ irrespective of the Talbot interference distance.

Although the imaging unit 12 does not configure the Talbot interferometer, as described above, a Talbot interference distance Z that is obtained if the first absorption type grating 31 diffracts the X-ray is expressed by a following equation (3) using the grating pitch p₁ of the first absorption type grating 31, the grating pitch p₂ of the second absorption type grating 32, the X-ray wavelength (peak wavelength) λ and a positive integer m.

$$\begin{matrix}[ equation 3 ] & \\ Z = m \frac{{p}_{1} {p}_{2}}{λ} & ( 3 )\end{matrix}$$

The equation (3) indicates a Talbot interference distance when the X-ray irradiated from the X-ray source 11 is a conical beam and is known by Atsushi Momose, et al. (Japanese Journal of Applied Physics, Vol. 47, No. 10, 2008, August, page 8077).

In the X-ray imaging system 10, the distance L₂ is set to be shorter than the minimum Talbot interference distance Z when m=1 so as to make the imaging unit 12 smaller. That is, the distance L₂ is set by a value within a range satisfying a following equation (4).

$$\begin{matrix}[ equation 4 ] & \\ {L}_{2} < \frac{{p}_{1} {p}_{2}}{λ} & ( 4 )\end{matrix}$$

In addition, when the X-ray irradiated from the X-ray source 11 can be considered as a substantially parallel beam, the Talbot interference distance Z is expressed by a following equation (5) and the distance L₂ is set by a value within a range satisfying a following equation (6).

$$\begin{matrix}[ equation 5 ] & \\ Z = m \frac{{p}_{1}^{2}}{λ} & ( 5 ) \\ [ equation 6 ] & \\ {L}_{2} < \frac{{p}_{1}^{2}}{λ} & ( 6 )\end{matrix}$$

In order to generate a period pattern image having high contrast, it is preferable that the X-ray shield units 31b, 32b perfectly shield (absorb) the X-ray. However, even when the materials (gold, platinum and the like) having excellent X-ray absorption ability are used, many X-rays penetrate the X-ray shield units without being absorbed. Accordingly, in order to improve the shield ability of X-ray, it is preferable to make thickness h₁, h₂ of the X-ray shield units 31b, 32b thicker as much as possible, respectively. For example, when the tube voltage of the X-ray tube 18 is 50 kV, it is preferable to shield 90% or more of the irradiated X-ray. In this case, the thickness h₁, h₂ are preferably 30 μm or larger, based on gold (Au).

In the meantime, when the thickness h₁, h₂ of the X-ray shield units 31b, 32b are excessively thickened, it is difficult for the obliquely incident X-ray to pass through the slits. Thereby, the so-called vignetting occurs, so that an effective field of view of the direction (x direction) orthogonal to the extending direction (strip band direction) of the X-ray shield units 31b, 32b is narrowed. Therefore, from a standpoint of securing the field of view, the upper limits of the thickness h₁, h₂ are defined. In order to secure a length V of the effective field of view in the x direction on the detection surface of the FPD 30, when a distance from the X-ray focal point 18b to the detection surface of the FPD 30 is L, the thickness h₁, h₂ are necessarily set to satisfy following equations (7) and (8), from a geometrical relation shown in FIG. 5.

$$\begin{matrix}[ equation 7 ] & \\ {h}_{1} \leq \frac{L}{V / 2} {d}_{1} & ( 7 ) \\ [ equation 8 ] & \\ {h}_{2} \leq \frac{L}{V / 2} {d}_{2} & ( 8 )\end{matrix}$$

For example, when d₁=2.5 μm, d₂=3.0 μm and L=2 m, assuming a typical imaging in a typical hospital, the thickness h₁ should be 100 μm or smaller and the thickness h₂ should be 120 μm or smaller so as to secure a length of 10 cm as the length V of the effective field of view in the x direction.

In the imaging unit 12 configured as described above, an intensity-modulated image is formed by the superimposition of the G1 image of the first absorption type grating 31 and the second absorption type grating 32 and is captured by the FPD 30. A pattern period p₁′ of the G1 image at the position of the second absorption type grating 32 and a substantial grating pitch p₂′ (substantial pitch after the manufacturing) of the second absorption type grating 32 are slightly different due to the manufacturing error or arrangement error. The arrangement error means that the substantial pitches of the first and second absorption type gratings 31, 32 in the x direction are changed as the inclination, rotation and the interval therebetween are relatively changed.

Due to the slight difference between the pattern period p₁′ of the G1 image and the grating pitch p₂′, the image contrast becomes a moiré fringe. A period T of the moiré fringe is expressed by a following equation (9).

$$\begin{matrix}[ equation 9 ] & \\ T = \frac{p {1}^{′} \times p {2}^{′}}{\vert p {1}^{′} - p {2}^{′} \vert} & ( 9 )\end{matrix}$$

When it is intended to detect the moiré fringe with the FPD 30, an arrangement pitch P of the pixels 40 in the x direction should satisfy at least a following equation (10) and preferably satisfy a following equation (11) (n: positive integer).

[equation 10]

P≠nT (10)

[equation 11]

P<T (11)

The equation (10) means that the arrangement pitch P is not an integer multiple of the moiré period T. Even for a case of n≧2, it is possible to detect the moiré fringe in principle. The equation (11) means that the arrangement pitch P is set to be smaller than the moiré period T.

Since the arrangement pitch P of the pixels 40 of the FPD 30 are design-determined (in general, about 100 μm) and it is difficult to change the same, when it is intended to adjust a magnitude relation of the arrangement pitch P and the moiré period T, it is preferable to adjust the positions of the first and second absorption type gratings 31, 32 and to change at least one of the pattern period p₁′ of the G1 image and the grating pitch p₂′, thereby changing the moiré period T.

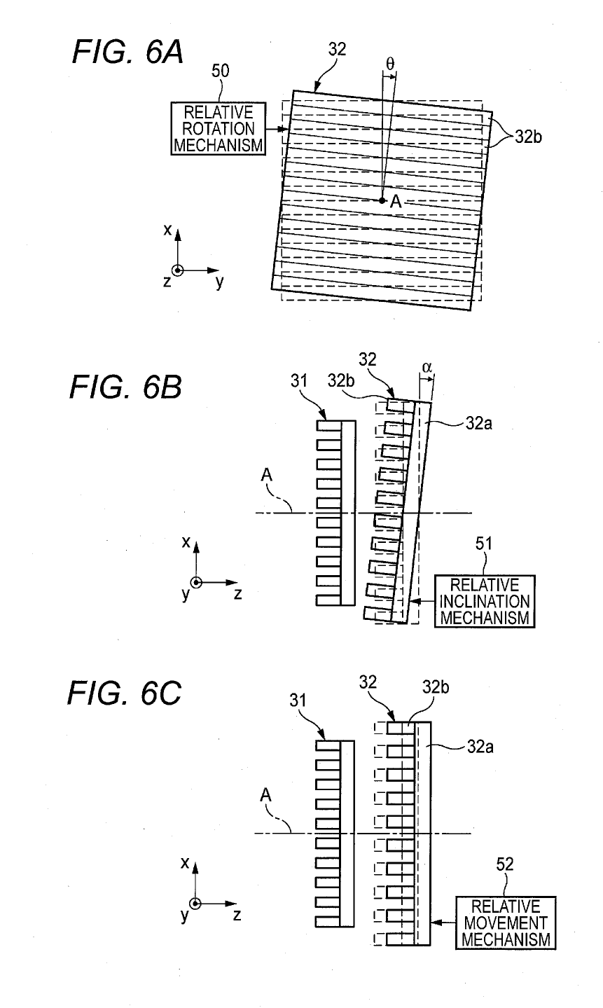

FIGS. 6A, 6B and 6C show methods of changing the moiré period T.

It is possible to change the moiré period T by relatively rotating one of the first and second absorption type gratings 31, 32 about the optical axis A. For example, there is provided a relative rotation mechanism 50 that rotates the second absorption type grating 32 relatively to the first absorption type grating 31 about the optical axis A. When the second absorption type grating 32 is rotated by an angle θ by the relative rotation mechanism 50, the substantial grating pitch in the x direction is changed from “p₂′” to “p₂′/cos θ”, so that the moiré period T is changed (refer to FIG. 6A).

As another example, it is possible to change the moiré period T by relatively inclining one of the first and second absorption type gratings 31, 32 about an axis orthogonal to the optical axis A and following the y direction. For example, there is provided a relative inclination mechanism 51 that inclines the second absorption type grating 32 relatively to the first absorption type grating 31 about an axis orthogonal to the optical axis A and following the y direction. When the second absorption type grating 32 is inclined by an angle α by the relative inclination mechanism 51, the substantial grating pitch in the x direction is changed from “p₂′” to “p₂′×cos α”, so that the moiré period T is changed (refer to FIG. 6B).

As another example, it is possible to change the moiré period T by relatively moving one of the first and second absorption type gratings 31, 32 along a direction of the optical axis A. For example, there is provided a relative movement mechanism 52 that moves the second absorption type grating 32 relatively to the first absorption type grating 31 along a direction of the optical axis A so as to change the distance L₂ between the first absorption type grating 31 and the second absorption type grating 32. When the second absorption type grating 32 is moved along the optical axis A by a moving amount δ by the relative movement mechanism 52, the pattern period of the G1 image of the first absorption type grating 31 projected at the position of the second absorption type grating 32 is changed from “p₁′” to “p₁′×(L₁+L₂+δ)/(L₁+L₂)”, so that the moiré period T is changed (refer to FIG. 6C).

In the X-ray imaging system 10, since the imaging unit 12 is not the Talbot interferometer and can freely set the distance L₂, it can appropriately adopt the mechanism for changing the distance L₂ to thus change the moiré period T, such as the relative movement mechanism 52. The changing mechanisms (the relative rotation mechanism 50, the relative inclination mechanism 51 and the relative movement mechanism 52) of the first and second absorption type gratings 31, 32 for changing the moiré period T can be configured by actuators such as piezoelectric devices.

When the photographic subject H is arranged between the X-ray source 11 and the first absorption type grating 31, the moiré fringe that is detected by the FPD 30 is modulated by the photographic subject H. An amount of the modulation is proportional to the angle of the X-ray that is deviated by the refraction effect of the photographic subject H. Accordingly, it is possible to generate the phase contrast image of the photographic subject H by analyzing the moiré fringe detected by the FPD 30.

In the below, an analysis method of the moiré fringe is described.

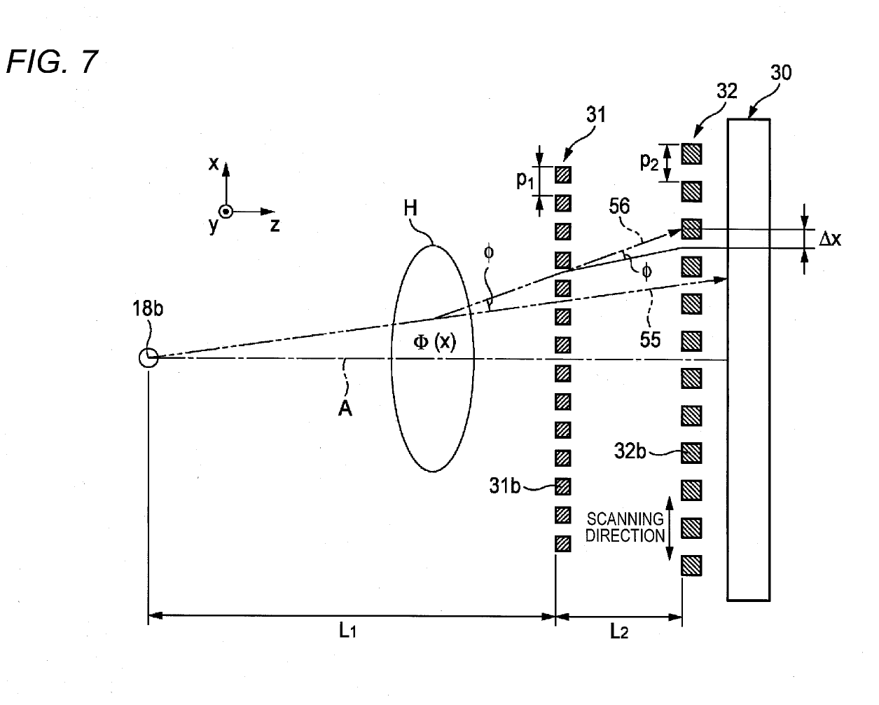

FIG. 7 shows one X-ray that is refracted in correspondence to a phase shift distribution Φ(x) in the x direction of the photographic subject H.

A reference numeral 55 indicates a path of the X-ray that goes straight when there is no photographic subject H. The X-ray traveling along the path 55 passes through the first and second absorption type gratings 31, 32 and is then incident onto the FPD 30. A reference numeral 56 indicates a path of the X-ray that is refracted and deviated by the photographic subject H. The X-ray traveling along the path 56 passes through the first absorption type grating 31 and is then shielded by the second absorption type grating 32.

The phase shift distribution Φ(x) of the photographic subject H is expressed by a following equation (12), when a refractive index distribution of the photographic subject H is indicated by n(x, z) and the traveling direction of the X-ray is indicated by z.

$$\begin{matrix}[ equation 12 ] & \\ Φ ( x ) = \frac{2 π}{λ} \int [ 1 - n ( x , z ) ] d z & ( 12 )\end{matrix}$$

The G1 image that is projected from the first absorption type grating 31 to the position of the second absorption type grating 32 is displaced in the x direction as an amount corresponding to a refraction angle φ, due to the refraction of the X-ray at the photographic subject H. An amount of displacement Δx is approximately expressed by a following equation (13), based on the fact that the refraction angle φ of the X-ray is slight.

[equation 13]

Δx≈L₂φ (13)

Here, the refraction angle φ is expressed by an equation (14) using a wavelength λ of the X-ray and the phase shift distribution Φ(x) of the photographic subject H.

$$\begin{matrix}[ equation 14 ] & \\ ϕ = \frac{λ}{2 π} \frac{\partial Φ ( x )}{\partial x} & ( 14 )\end{matrix}$$

Like this, the amount of displacement Δx of the G1 image due to the refraction of the X-ray at the photographic subject H is related to the phase shift distribution Φ(x) of the photographic subject H. Also, the amount of displacement Δx is related to a phase deviation amount ψ of a signal output from each pixel 40 of the FPD 30 (a deviation amount of a phase of a signal of each pixel 40 when there is the photographic subject H and when there is no photographic subject H), as expressed by a following equation (15).

$$\begin{matrix}[ equation 15 ] & \\ ψ = \frac{2 π}{{p}_{2}} Δ x = \frac{2 π}{{p}_{2}} {L}_{2} ϕ & ( 15 )\end{matrix}$$

Therefore, when the phase deviation amount ψ of a signal of each pixel 40 is calculated, the refraction angle φ is obtained from the equation (15) and a differential of the phase shift distribution Φ(x) is obtained by using the equation (14). Hence, by integrating the differential with respect to x, it is possible to generate the phase shift distribution Φ(x) of the photographic subject H, i.e., the phase contrast image of the photographic subject H. In the X-ray imaging system 10 of this illustrative embodiment, the phase deviation amount ψ is calculated by using a fringe scanning method that is described below.

In the fringe scanning method, an imaging is performed while one of the first and second absorption type gratings 31, 32 is stepwise translation-moved relatively to the other in the x direction (that is, an imaging is performed while changing the phases of the grating periods of both gratings). In the X-ray imaging system 10 of this illustrative embodiment, the second absorption type grating 32 is moved by the scanning mechanism 33. However, the first absorption type grating 31 may be moved. As the second absorption type grating 32 is moved, the moiré fringe is moved. When the translation distance (moving amount in the x direction) reaches one period (grating pitch p₂) of the grating period of the second absorption type grating 32 (i.e., when the phase change reaches 2π), the moiré fringe returns to its original position. Regarding the change of the moiré fringe, while moving the second absorption type grating 32 by 1/n (n: integer) with respect to the grating pitch p₂, the fringe images are captured by the FPD 30 and the signals of the respective pixels 40 are obtained from the captured fringe images and calculated in the calculation processing unit 22, so that the phase deviation amount ψ of the signal of each pixel 40 is obtained.

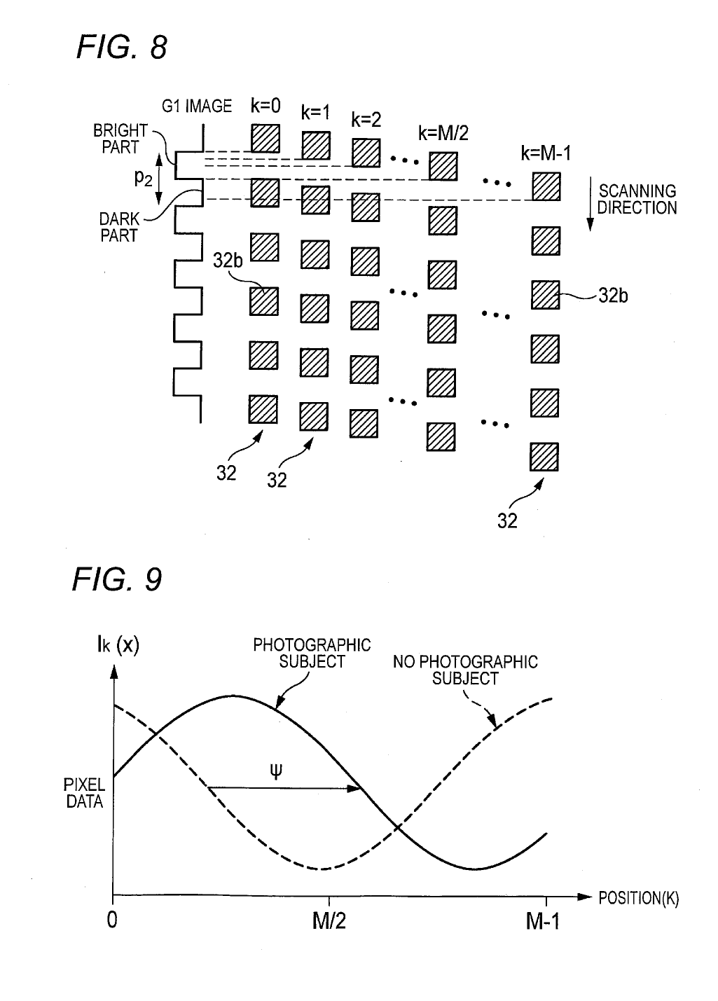

FIG. 8 pictorially shows that the second absorption type grating 32 is moved with a scanning pitch (p₂/M) (M: integer of 2 or larger) that is obtained by dividing the grating pitch p₂ into M.

The scanning mechanism 33 sequentially translation-moves the second absorption type grating 32 to each of M scanning positions of k=0, 1, 2, . . . , M−1. In FIG. 8, an initial position of the second absorption type grating 32 is a position (k=0) at which a dark part of the G1 image at the position of the second absorption type grating 32 when there is no photographic subject H substantially coincides with the X-ray shield unit 32b. However, the initial position may be any position of k=0, 1, 2, . . . , M−1.

First, at the position of k=0, mainly, the X-ray that is not refracted by the photographic subject H passes through the second absorption type grating 32. Then, when the second absorption type grating 32 is moved in order of k=1, 2, . . . , regarding the X-ray passing through the second absorption type grating 32, the component of the X-ray that is not refracted by the photographic subject H is decreased and the component of the X-ray that is refracted by the photographic subject H is increased. In particular, at the position of k=M/2, mainly, only the X-ray that is refracted by the photographic subject H passes through the second absorption type grating 32. At the position exceeding k=M/2, contrary to the above, regarding the X-ray passing through the second absorption type grating 32, the component of the X-ray that is refracted by the photographic subject H is decreased and the component of the X-ray that is not refracted by the photographic subject H is increased.

At each position of k=0, 1, 2, . . . , M−1, when the imaging is performed by the FPD 30, M signal values (M Image data) are obtained for the respective pixels 40. In the below, a method of calculating the phase deviation amount ψ of the signal of each pixel 40 from the M signal values is described. When a signal value of each pixel 40 at the position k of the second absorption type grating 32 is indicated with Iₖ(x), Iₖ(x) is expressed by a following equation (16).

$$\begin{matrix}[ equation 16 ] & \\ {I}_{k} ( x ) = {A}_{0} + {\sum }_{n > 0} {A}_{n} exp [ 2 πi \frac{n}{{p}_{2}} \{ {L}_{2} ϕ ( x ) + \frac{{kp}_{2}}{M} \} ] & ( 16 )\end{matrix}$$

Here, x is a coordinate of the pixel 40 in the x direction, A₀ is the intensity of the incident X-ray and Aₙ is a value corresponding to the contrast of the signal value of the pixel 40 (n is a positive integer). Also, φ(x) indicates the refraction angle φ as a function of the coordinate x of the pixel 40.

Then, when a following equation (17) is used, the refraction angle φ(x) is expressed by a following equation (18).

$$\begin{matrix}[ equation 17 ] & \\ {\sum }_{k = 0}^{M - 1} exp ( - 2 πi \frac{k}{M} ) = 0 & ( 17 ) \\ [ equation 18 ] & \\ ϕ ( x ) = \frac{{p}_{2}}{2 π {L}_{2}} arg [ {\sum }_{K = 0}^{M - 1} {I}_{k} ( x ) exp ( - 2 π i \frac{k}{M} ) ] & ( 18 )\end{matrix}$$

Here, arg[ ] means the extraction of an angle of deviation and corresponds to the phase deviation amount ψ of the signal of each pixel 40. Therefore, from the M signal values obtained from the respective pixels 40, the phase deviation amount ψ of the signal of each pixel 40 is calculated based on the equation (18), so that the refraction angle φ(x) is acquired.

FIG. 9 shows a signal of one pixel of the radiological image detector, which is changed depending on the fringe scanning.

The M signal values obtained from the respective pixels 40 are periodically changed with the period of the grating pitch p₂ with respect to the position k of the second absorption type grating 32. The broken line of FIG. 9 indicates the change of the signal value when there is no photographic subject H and the solid line of FIG. 9 indicates the change of the signal value when there is the photographic subject H. A phase difference of both waveforms corresponds to the phase deviation amount ψ of the signal of each pixel 40.

Since the refraction angle φ(x) is a value corresponding to the differential phase value, as shown with the equation (14), the phase shift distribution Φ(x) is obtained by integrating the refraction angle φ(x) along the x axis. In the above descriptions, a y coordinate of the pixel 40 in the y direction is not considered. However, by performing the same calculation for each y coordinate, it is possible to obtain the two-dimensional phase shift distribution Φ(x, y) in the x and y directions. The above calculations are performed by the calculation processing unit 22 and the calculation processing unit 22 stores the phase contrast image in the storage unit 23.

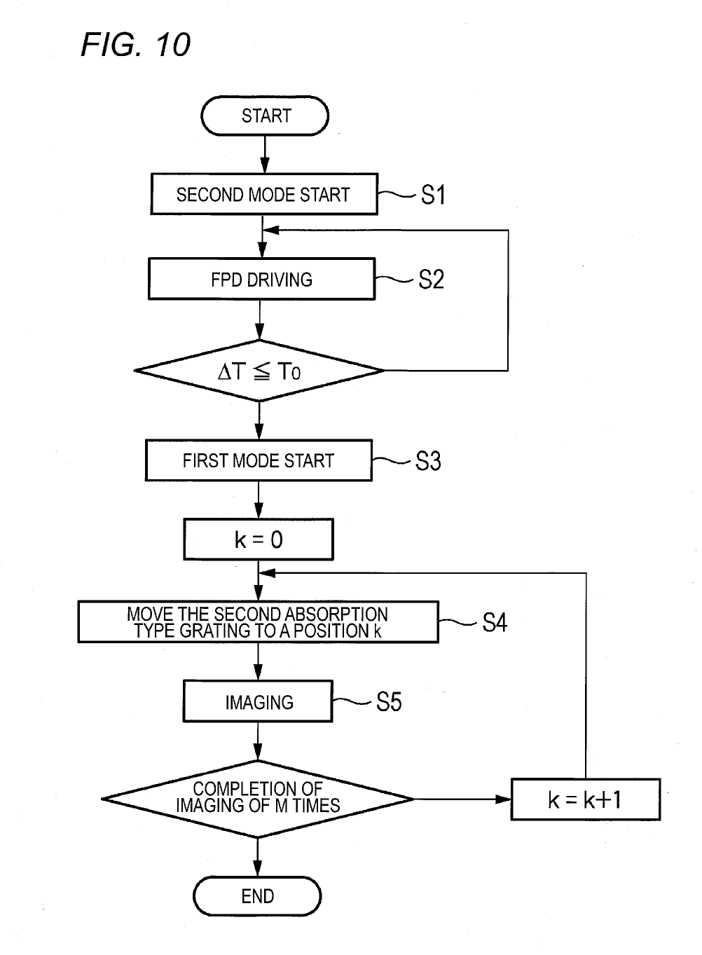

FIG. 10 shows an imaging process in the radiographic system of FIG. 1.

In the generation process of the phase contrast image, the change of the signal value of each pixel 40 for calculating the phase deviation amount ψ is necessarily brought about by the scanning of the second absorption type grating 32. Meanwhile, the signal value of each pixel 40 includes an offset component that is caused due to the dark current of the pixel 40 or temperature drift of the readout circuit 43. The offset component is varied depending on the temperature of the pixel 40 or readout circuit 43. The offset variation during the imaging causes the change of the signal value of each pixel 40, separately from the scanning of the second absorption type grating 32. Accordingly, it is necessary to sufficiently suppress the offset variation during the imaging.

The X-ray imaging system 10 of this illustrative embodiment has a first mode in which the X-ray imaging system performs a plurality of imaging by the fringe scanning and a second mode in which the X-ray imaging system performs a preparation operation for suppressing an offset variation during the imaging in the first mode.

When an operator inputs an imaging instruction through the input device 21 of the console 13, the control device 20 starts up the second mode (step S1). In the second imaging mode, the X-ray source 11 is not driven and the FPD 30 is repeatedly driven without being exposed (step S2).

The FPD 30 accumulates the charges in the respective pixels 40, reads out the charges accumulated in the respective pixels 40 and resets the remaining charges of the respective pixels 40. Thereby, the pixels 40 and the readout circuit 43 generate heat and the temperatures thereof are increased. As the temperatures are increased, the offset is typically increased. By repeating the cycle of the charge accumulation, the charge reading and the reset, the heat generation and the heat radiation in the pixels 40 and the readout circuit 43 are balanced, so that a steady state is made, the temperatures of the pixels 40 and the readout circuit 43 are stabilized and the offset is also stabilized.

The X-ray imaging system 10 of this illustrative embodiment is provided with a temperature sensor (not shown) that detects the temperature of the readout circuit 43. The control device 20 determines whether the FPD 30 is in the steady state, based on the temperature detected by the temperature sensor. The control device 20 acquires the temperatures of the readout circuit 43 before and after the operation of one cycle. When an absolute value of a temperature difference (ΔT) before and after the operation of one cycle is smaller than a preset threshold (ΔT₀), the control device determines that the FPD 30 is in the steady state. The threshold (ΔT₀) is appropriately determined based on control conditions of the FPD 30 such as driving frequency, driving voltage and the like. In a typical FPD, the threshold (ΔT₀) may be about 0.5° C.

When it is determined that the FPD 30 is in the steady state, the control device 20 switches from the second mode to the first mode (step S3). In the first mode, the X-ray source 11 is driven to irradiate the X-ray toward the photographic subject H and a plurality of imaging is performed while scanning the second absorption type grating 32 (steps S4 to S6).

The FPD 30 is in the steady state, so that the temperatures of the pixels 40 and the readout circuit 43 are stable and the offset is also stable even when the plurality of imaging is continuously performed. Therefore, the changes of the signal values of the respective pixels 40 that are obtained by the plurality of imaging are brought about by the scanning of the second absorption type grating 32.

It is preferable that the control conditions of the FPD 30 in the second mode are the same as those of the FPD 30 in the first mode. It may be possible to reduce the time that is necessary for the FPD 30 to reach the steady state by increasing the driving frequency or driving voltage (operation voltage of the readout circuit 43 and the like), for example. When it is intended to increase the driving frequency, it may be possible to reduce a charge accumulation period and to reduce the reading period by reading out only the charges of parts of the pixels in reading out the charges, for example.

Also, when it is intended to acquire the changes of the signal values of the respective pixels 40, which are caused due to the scanning of the second absorption type grating 32, it is sufficient inasmuch as the offset is stable during the plurality of imaging and it is not necessary to remove the offset components that are included in the signal values of the respective pixels 40. However, the offset correction for removing the offset components may be executed. Here, since the FPD 30 is in the steady state and the offset variation during the imaging is thus sufficiently suppressed, it is not necessary to acquire the data for correction every imaging. For example, the offset correction may be performed for the image data acquired in each imaging in a correction circuit that is included in the readout circuit 43 by driving the FPD 30 without the X-ray exposure to acquire the data for correction and using the same, before performing the plurality of imaging.

After the operator inputs the imaging instruction through the input device 21, the respective units operate in cooperation with each other under control of the control device 20, so that the preparation operation in the second mode, the plurality of imaging in the first mode and the generation process of the phase contrast image are automatically performed and the phase contrast image of the photographic subject H is finally displayed on the monitor 24.

As described above, according to the X-ray imaging system 10 of this illustrative embodiment, the FPD 30 is repeatedly driven in the second mode and is thus put in the steady state. After the FPD 30 is in the steady state, the X-ray imaging system shifts to the first mode and performs the plurality of imaging for the photographic subject H. In the steady state, the temperature variation of the FPD 30 and the offset variation depending on the temperature are suppressed. Thus, it is possible to prevent the signal values of the respective pixels of the image data, which is output from the FPD 30, from being changed due to the offset variation, during the plurality of imaging in the first mode, and to securely acquire the changes of the signal values of the respective pixels based on the displacement of the second absorption type grating 32. Thereby, it is possible to improve the quality of the phase contrast image.

Also, the X-ray is not mostly diffracted at the first absorption type grating 31 and is geometrically projected to the second absorption type grating 32. Accordingly, it is not necessary for the irradiated X-ray to have high spatial coherence and thus it is possible to use a general X-ray source that is used in the medical fields, as the X-ray source 11. In the meantime, since it is possible to arbitrarily set the distance L₂ from the first absorption type grating 31 to the second absorption type grating 32 and to set the distance L₂ to be smaller than the minimum Talbot interference distance of the Talbot interferometer, it is possible to miniaturize the imaging unit 12. Further, in the X-ray imaging system of this illustrative embodiment, since the substantially entire wavelength components of the irradiated X-ray contribute to the projection image (G1 image) from the first absorption type grating 31 and the contrast of the moiré fringe is thus improved, it is possible to improve the detection sensitivity of the phase contrast image.

Also, in the X-ray imaging system 10, the refraction angle φ is calculated by performing the fringe scanning for the projection image of the first grating. Thus, it has been described that both the first and second gratings are the absorption type gratings. However, the invention is not limited thereto. As described above, the invention is also useful even when the refraction angle φ is calculated by performing the fringe scanning for the Talbot interference image. Accordingly, the first grating is not limited to the absorption type grating and may be a phase type grating. Also, the analysis method of the moiré fringe that is formed by the superimposition of the X-ray image of the first grating and the second grating is not limited to the above fringe scanning method. For example, a variety of methods using the moiré fringe, such as method of using Fourier transform/inverse Fourier transform known in “J. Opt. Soc. Am. Vol. 72, No. 1 (1982) p. 156”, may be also applied.

Also, it has been described that the X-ray imaging system 10 stores or displays, as the phase contrast image, the image based on the phase shift distribution Φ. However, as described above, the phase shift distribution Φ is obtained by integrating the differential of the phase shift distribution Φ obtained from the refraction angle φ, and the refraction angle φ and the differential of the phase shift distribution Φ are also related to the phase change of the X-ray by the photographic subject. Accordingly, the image based on the refraction angle φ and the image based on the differential of the phase shift distribution Φ are also included in the phase contrast image.

In addition, it may be possible to prepare a phase differential image (differential amount of the phase shift distribution Φ) from an image data group that is acquired by performing the imaging (pre-imaging) at a state in which there is no photographic subject. The phase differential image reflects the phase non-uniformity of a detection system (that is, the phase differential image includes a phase deviation by the moiré, a grid non-uniformity, and the like). Also, by preparing a phase differential image from an image data group that is acquired by performing the imaging (main imaging) at a state in which there is a photographic subject and subtracting the phase differential image acquired in the pre-imaging from the phase differential image acquired in the main imaging, it is possible to acquire a phase differential image in which the phase non-uniformity of a measuring system is corrected.

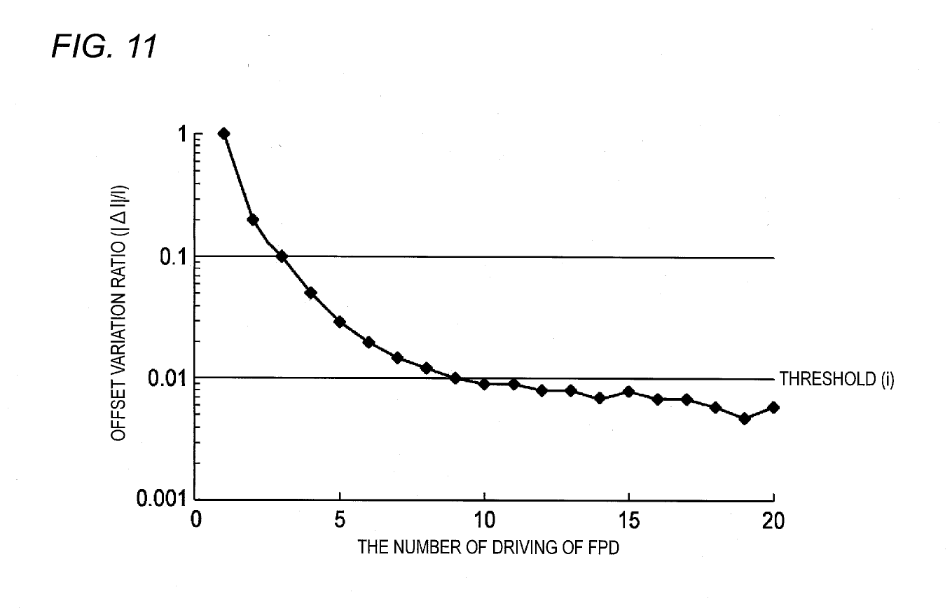

FIG. 11 shows a method of determining a steady state of a radiological image detector in another example of a radiographic system for illustrating an illustrative embodiment of the invention.

The X-ray imaging system of this illustrative embodiment has a first mode in which the X-ray imaging system performs a plurality of imaging by the fringe scanning and a second mode in which the X-ray imaging system performs a preparation operation for suppressing an offset variation during the imaging in the first mode. In the second mode, the FPD 30 is repeatedly driven without the X-ray exposure and is thus put in the steady state. It is determined whether the FPD 30 is in the steady state, based on the variation of the signal values of one or more pixels of the image data that is output from the FPD 30. Since the other configurations are the same as the X-ray imaging system 10, the descriptions thereof are omitted.

When the operator inputs an imaging instruction through the input device 21 of the console 13, the control device 20 starts up the second mode. In the second imaging mode, the X-ray source 11 is not driven and the FPD 30 is repeatedly driven without the X-ray exposure. The image data, which is output from the FPD 30 that is repeatedly driven without the X-ray exposure, reflects the offset that is caused due to the dark current of the pixels 40 or temperature drift of the readout circuit 43.

In the X-ray imaging system of this illustrative embodiment, the image data that is output from the FPD 30 is input into the calculation processing unit 22 of the console 13 and the calculation processing unit 22 calculates an average of the signal values of the respective pixels 40 configuring the image data. The control device 20 determines whether the FPD 30 is in the steady state, based on the average signal value calculated in the calculation processing unit 22. Whenever the image data is output from the FPD 30 that is repeatedly driven, the control device 20 acquires the average signal value I of the image data. When a ratio (offset variation ratio) |ΔI|/I of an absolute value of a difference ΔI with the average signal value of the image data in previous time and the average signal value I is smaller than a preset threshold i, the control device 20 determines that the FPD 30 is in the steady state. The threshold i is appropriately determined based on the control conditions of the FPD 30 such as driving frequency, driving voltage and the like. In a typical FPD, the threshold may be about 1%. Also, when determining whether the FPD 30 is in the steady state, it may be possible to use a signal value of a specific pixel 40, instead of the average of the signal values of the respective pixels 40.

When it is determined that the FPD 30 is in the steady state, the control device 20 switches from the second mode to the first mode. In the first mode, the X-ray source 11 is also driven to irradiate the X-ray toward the photographic subject H and a plurality of imaging is performed while scanning the second absorption type grating 32.

The FPD 30 is in the steady state, so that the temperatures of the pixels 40 and the readout circuit 43 are stable and the offset is also stable even when the plurality of imaging is continuously performed. Therefore, the changes of the signal values of the respective pixels 40 that are obtained by the plurality of imaging are brought about by the scanning of the second absorption type grating 32.

According to the X-ray imaging system 60 of this illustrative embodiment, it is determined whether the FPD 30 is in the steady state, based on the offset variation ratio and it is possible to suppress the offset variation during the imaging in the first mode, more securely.

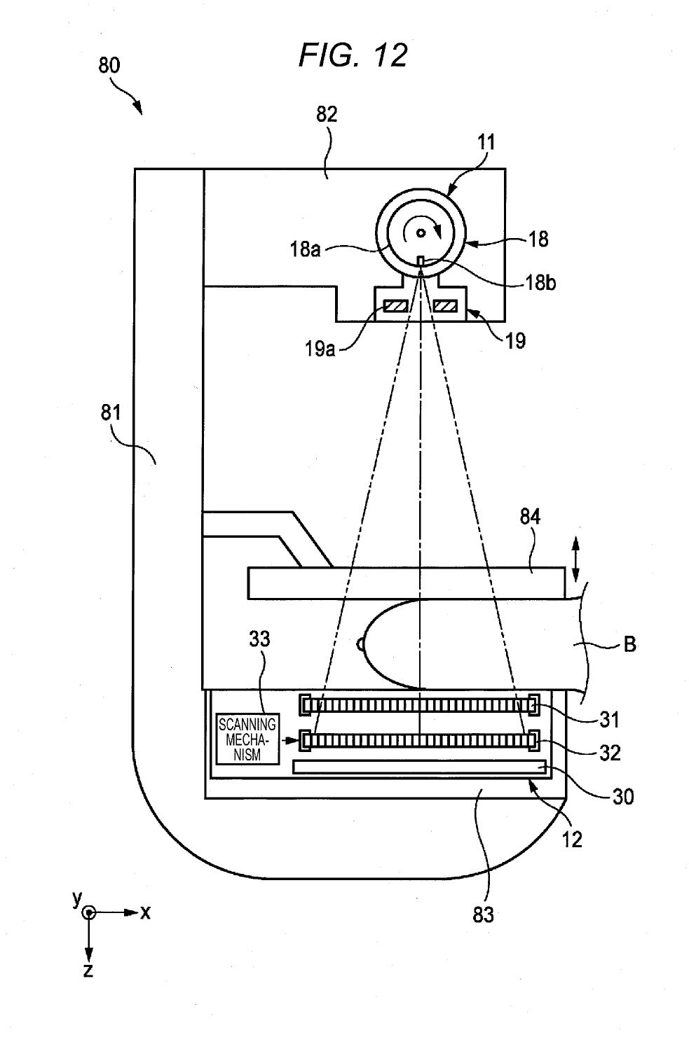

FIG. 12 shows another example of the radiographic system for illustrating an illustrative embodiment of the invention.

A mammography apparatus 80 shown in FIG. 12 is an apparatus of capturing an X-ray image (phase contrast image) of a breast B that is the photographic subject. The mammography apparatus 80 includes an X-ray source accommodation unit 82 that is mounted to one end of an arm member 81 rotatably connected to a base platform (not shown), an imaging platform 83 that is mounted to the other end of the arm member 81 and a pressing plate 84 that is configured to vertically move relatively to the imaging platform 83.

The X-ray source 11 is accommodated in the X-ray source accommodation unit 82 and the imaging unit 12 is accommodated in the imaging platform 83. The X-ray source 11 and the imaging unit 12 are arranged to face each other. The pressing plate 84 is moved by a moving mechanism (not shown) and presses the breast B between the pressing plate and the imaging platform 83. At this pressing state, the X-ray imaging is performed.

Also, the configurations of the X-ray source 11 and the imaging unit 12 are the same as those of the X-ray imaging system 10. Therefore, the respective constitutional elements are indicated with the same reference numerals as the X-ray imaging system 10. Since the other configurations and the operations are the same, the descriptions thereof are also omitted.

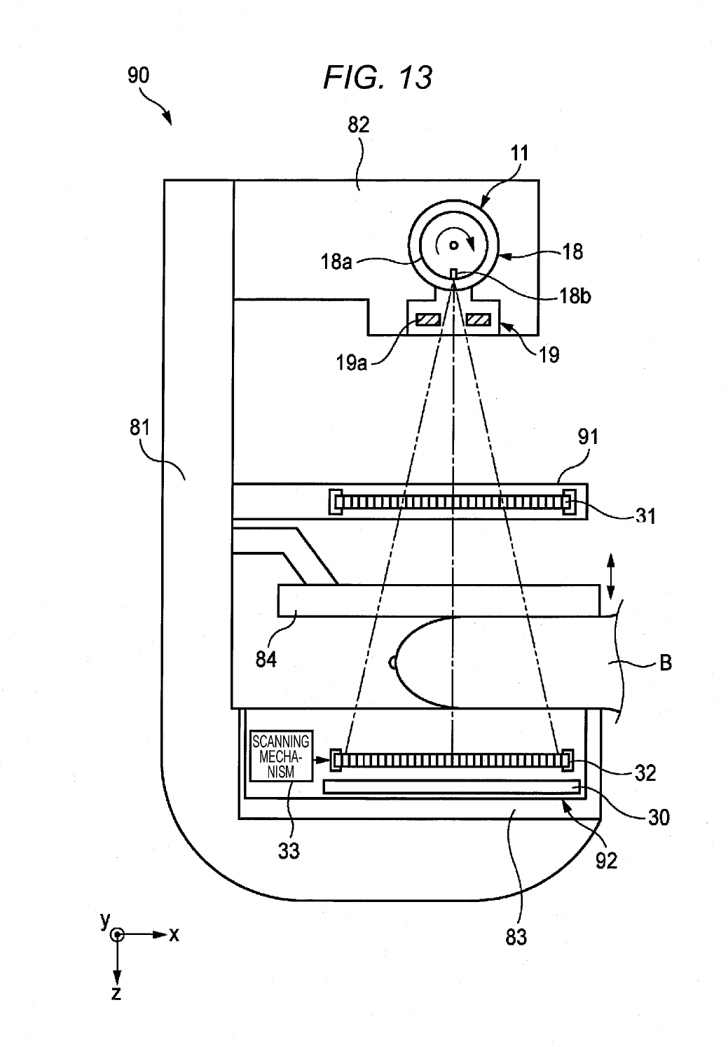

FIG. 13 shows a modified embodiment of the radiographic system of FIG. 12.

A mammography apparatus 90 shown in FIG. 13 is different from the mammography apparatus 80 in that the first absorption type grating 31 is provided between the X-ray source 11 and the pressing plate 84. The first absorption type grating 31 is accommodated in a grating accommodation unit 91 that is connected to the arm member 81. An imaging unit 92 is configured by the FPD 30, the second absorption type grating 32 and the scanning mechanism 33.

Like this, even when the object to be diagnosed (breast) B is positioned between the first absorption type grating 31 and the second absorption type grating 32, the projection image (G1 image) of the first absorption type grating 31, which is formed at the position of the second absorption type grating 32, is deformed by the object to be diagnosed B. Accordingly, also in this case, it is possible to detect the moiré fringe, which is modulated due to the object to be diagnosed B, by the FPD 30. That is, also with the mammography apparatus 90, it is possible to obtain the phase contrast image of the object to be diagnosed B by the above-described principle.

In the mammography apparatus 90, since the X-ray whose radiation dose has been substantially halved by the shielding of the first absorption type grating 31 is irradiated to the object to be diagnosed B, it is possible to decrease the radiation exposure amount of the object to be diagnosed B about by half, compared to the above mammography apparatus 80. In the meantime, like the mammography apparatus 90, the configuration in which the object to be diagnosed is arranged between the first absorption type grating 31 and the second absorption type grating 32 can be applied to the above X-ray imaging system 10.

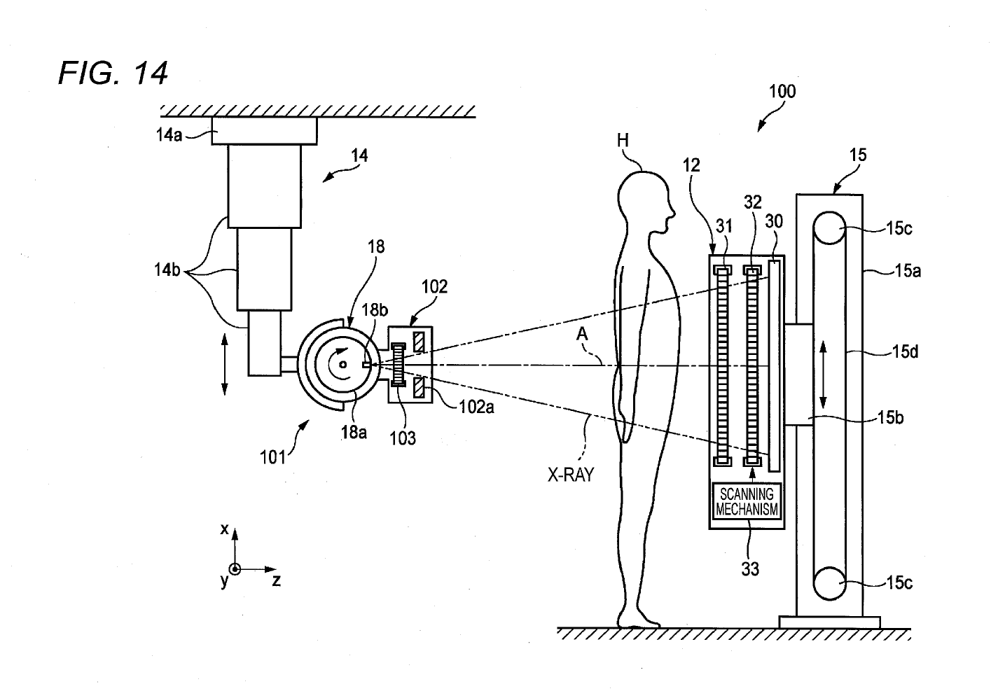

FIG. 14 shows another example of the radiographic system for illustrating an illustrative embodiment of the invention.

A X-ray imaging system 100 is different from the X-ray imaging system 10 in that a multi-slit 103 is provided to a collimator unit 102 of an X-ray source 101. Since the other configurations are the same as the above X-ray imaging system 10, the descriptions thereof are omitted.

In the above X-ray imaging system 10, when the distance from the X-ray source 11 to the FPD 30 is set to be same as a distance (1 to 2 m) that is set in an imaging room of a typical hospital, the blurring of the G1 image may be influenced by a focus size (in general, about 0.1 mm to 1 mm) of the X-ray focal point 18b, so that the quality of the phase contrast image may be deteriorated. Accordingly, it may be considered that a pin hole is provided just after the X-ray focal point 18b to effectively reduce the focus size. However, when an opening area of the pin hole is decreased so as to reduce the effective focus size, the X-ray intensity is lowered. In the X-ray imaging system 100 of this illustrative embodiment, in order to solve this problem, the multi-slit 103 is arranged just after the X-ray focal point 18b.

The multi-slit 103 is an absorption type grating (i.e., third absorption grating) having the same configuration as the first and second absorption type gratings 31, 32 provided to the imaging unit 12 and has a plurality of X-ray shield units extending in one direction (y direction, in this illustrative embodiment), which are periodically arranged in the same direction (x direction, in this illustrative embodiment) as the X-ray shield units 31b, 32b of the first and second absorption type gratings 31, 32. The multi-slit 103 is to partially shield the radiation emitted from the X-ray source 11, thereby reducing the effective focus size in the x direction and forming a plurality of point light sources (disperse light sources) in the x direction.

It is necessary to set a grating pitch p₃ of the multi-slit 103 so that it satisfies a following equation (19), when a distance from the multi-slit 103 to the first absorption type grating 31 is L₃.

$$\begin{matrix}[ equation 19 ] & \\ {p}_{3} = \frac{{L}_{3}}{{L}_{2}} {p}_{2} & ( 19 )\end{matrix}$$

The equation (19) is a geometrical condition so that the projection images (G1 images) of the X-rays, which are emitted from the respective point light sources dispersedly formed by the multi-slit 103, by the first absorption type grating 31 coincide (overlap) at the position of the second absorption type grating 32.

Also, since the position of the multi-slit 103 is substantially the X-ray focus position, the grating pitch p₂ and the interval d₂ of the second absorption type grating 32 are determined to satisfy following equations (20) and (21).

$$\begin{matrix}[ equation 20 ] & \\ {p}_{2} = \frac{{L}_{3} + {L}_{2}}{{L}_{3}} {p}_{1} & ( 20 ) \\ [ equation 21 ] & \\ {d}_{2} = \frac{{L}_{3} + {L}_{2}}{{L}_{3}} {d}_{1} & ( 21 )\end{matrix}$$

Like this, in the X-ray imaging system 100 of this illustrative embodiment, the G1 images based on the point light sources formed by the multi-slit 103 overlap, so that it is possible to improve the quality of the phase contrast image without lowering the X-ray intensity. The above multi-slit 103 can be applied to any of the X-ray imaging systems.

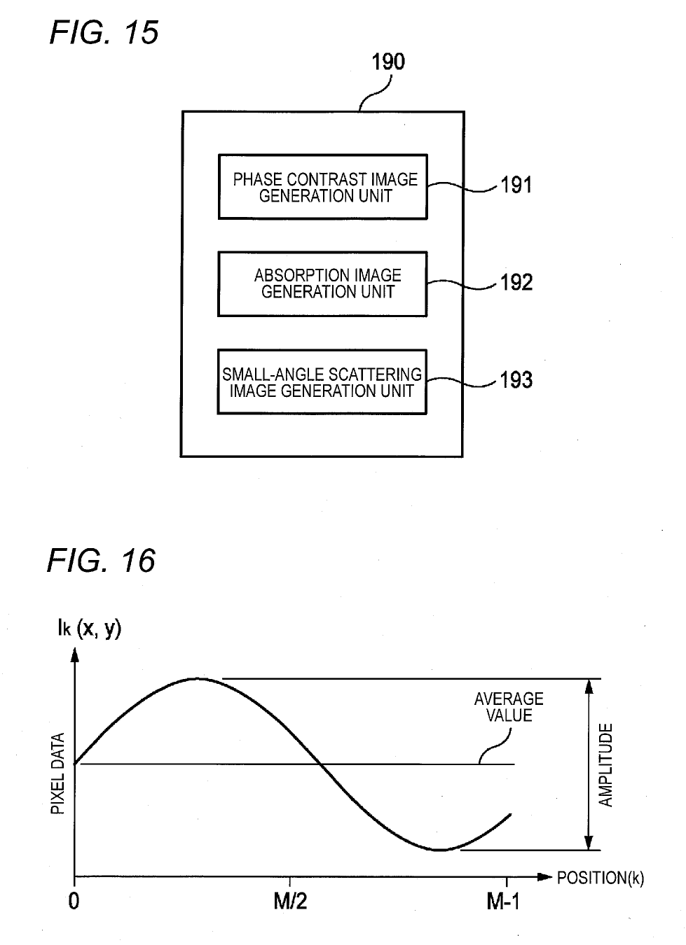

FIG. 15 shows a configuration of a calculation processing unit in accordance with another example of a radiographic system for illustrating an illustrative embodiment of the invention.

According to the respective X-ray imaging systems, it is possible to acquire a high contrast image (phase contrast image) of an X-ray weak absorption object that cannot be easily represented. Further, to refer to the absorption image in correspondence to the phase contrast image is helpful to the image reading. For example, it is effective to superimpose the absorption image and the phase contrast image by the appropriate processes such as weighting, gradation, frequency process and the like and to thus supplement a part, which cannot be represented by the absorption image, with the information of the phase contrast image. However, when the absorption image is captured separately from the phase contrast image, the capturing positions between the capturing of the phase contrast image and the capturing of the absorption image are deviated to make the favorable superimposition difficult. Also, the burden of the object to be diagnosed is increased as the number of the imaging is increased. In addition, in recent years, a small-angle scattering image attracts attention in addition to the phase contrast image and the absorption image. The small-angle scattering image can represent tissue characterization and state caused due to the fine structure in the photographic subject tissue. For example, in fields of cancers and circulatory diseases, the small-angle scattering image is expected as a representation method for a new image diagnosis.

Accordingly, the X-ray imaging system of this illustrative embodiment uses a calculation processing unit 190 that enables the generation of the absorption image of small-angle scattering image from image data groups acquired for the phase contrast image. The calculation processing unit 190 has a phase contrast image generation unit 191, an absorption image generation unit 192 and a small-angle scattering image generation unit 193. The units perform the calculation processes, based on the image data groups that are acquired by the imaging at the respective M scanning positions of k=0, 1, 2, . . . , M−1. Among them, the phase contrast image generation unit 191 generates a phase contrast image in accordance with the above-described process.

The absorption image generation unit 192 averages the signal values Iₖ(x, y), which are obtained for each pixel, with respect to k, as shown in FIG. 19, and thus calculates an average value and images the image data, thereby generating an absorption image. Also, the calculation of the average value may be performed simply by averaging the signal values Iₖ(x, y) with respect to k. However, when M is small, an error is increased. Accordingly, after fitting the signal values Iₖ(x, y) with a sinusoidal wave, an average value of the fitted sinusoidal wave may be calculated. In addition, when generating the absorption image, the invention is not limited to the using of the average value. For example, an addition value that is obtained by adding the signal values Iₖ(x, y) with respect to k may be used inasmuch as it corresponds to the average value.

The absorption image is obtained by making a picture of the average value of the M signal values of the respective pixels 40 or the additional value itself, as the image contrast. The non-uniformity of the offset components included in the signal values of the respective pixels 40 has an effect on the image contrast. Therefore, it is preferable to perform the offset correction for each of the image data groups.

In the meantime, it may be possible to prepare an absorption image from an image data group that is acquired by performing the imaging (pre-imaging) at a state in which there is no photographic subject. The absorption image reflects a transmittance non-uniformity of a detection system (that is, the absorption image includes information such as a transmittance non-uniformity of grids, an absorption influence of a radiation dose detector, and the like). Therefore, from the image, it is possible to prepare a correction coefficient map for correcting the transmittance non-uniformity of the detection system. Also, by preparing an absorption image from an image data group that is acquired by performing the imaging (main imaging) at a state in which there is a photographic subject and multiplying the respective pixels with the correction coefficient, it is possible to acquire an absorption image of the photographic subject in which the transmittance non-uniformity of the detection system is corrected.

The small-angle scattering image generation unit 193 calculates an amplitude value of the signal values Iₖ(x, y), which are obtained for each pixel, and thus images the image data, thereby generating a small-angle scattering image. Meanwhile, the amplitude value may be calculated by calculating a difference between the maximum and minimum values of the signal values Iₖ(x, y). However, when M is small, an error is increased. Accordingly, after fitting the signal values Iₖ(x, y) with a sinusoidal wave, an amplitude value of the fitted sinusoidal wave may be calculated. In addition, when generating the small-angle scattering image, the invention is not limited to the using of the amplitude value. For example, a variance value, a standard error and the like may be used as an amount corresponding to the non-uniformity about the average value.

In the meantime, it may be possible to prepare a small-angle scattering image from the image data group that is acquired by performing the imaging (pre-imaging) at a state in which there is no photographic subject. The small-angle scattering image reflects amplitude value non-uniformity of a detection system (that is, the small-angle scattering image includes information such as pitch non-uniformity of grids, opening ratio non-uniformity, non-uniformity due to the relative position deviation between the grids, and the like). Therefore, from the image, it is possible to prepare a correction coefficient map for correcting the amplitude value non-uniformity of the detection system. Also, by preparing a small-angle scattering image from an image data group that is acquired by performing the imaging (main imaging) at a state in which there is a photographic subject and multiplying the respective pixels with the correction coefficient, it is possible to acquire a small-angle scattering image of the photographic subject in which the amplitude value non-uniformity of the detection system is corrected.

According to the X-ray imaging system of this illustrative embodiment, the absorption image or small-angle scattering image is generated from the image data group acquired for the phase contrast image of the photographic subject. Accordingly, the capturing positions between the capturing of the phase contrast image and the capturing of the absorption image are not deviated, so that it is possible to favorably superimpose the phase contrast image and the absorption image or small-angle scattering image. Also, it is possible to reduce the burden of the photographic subject, compared to a configuration in which the imaging is separately performed so as to acquire the absorption image and the small-angle scattering image.

In the respective X-ray imaging systems, it has been described that the general X-ray is used as the radiation. However, the radiation that is used for the invention is not limited to the X-ray. For example, the radiations except for the X-ray, such as α-ray and γ-ray, may be also used.

As described above, the specification discloses a radiographic system that includes a first grating; a second grating having a period that substantially coincides with a pattern period of a radiological image formed by radiation having passed through the first grating; a radiological image detector that detects the radiological image masked by the second grating and outputs image data of the detected radiological image, and a control unit that performs a switching between a first mode in which a plurality of imaging is performed with the second grating being positioned at relative positions having different phases with regard to the radiological image and a second mode in which the radiological image detector is driven without radiation exposure, wherein the control unit repeatedly drives the radiological image detector in the second mode until the radiological image detector is in a steady state and shifts to the first mode after the radiological image detector is in the steady state.

Also, according to the radiographic system disclosed in the specification, the control unit may determine whether the radiological image detector is in the steady state, based on a temperature of an output circuit unit of the radiological image detector that outputs the image data.

Also, according to the radiographic system disclosed in the specification, the control unit may determine that the radiological image detector is in the steady state when a temperature difference of the output circuit unit before and after the radiological image detector is driven is a preset threshold or smaller.

Also, according to the radiographic system disclosed in the specification, the control unit may determine whether the radiological image detector is in the steady state, based on signal values of one or more pixels configuring the image data.

Also, according to the radiographic system disclosed in the specification, the control unit may determine that the radiological image detector is in the steady state when a variation ratio of the signal values of the one or more pixels is a preset threshold or smaller.

Also, according to the radiographic system disclosed in the specification, a driving frequency of the radiological image detector in the second mode may be higher than that of the radiological image detector in the first mode.

Also, according to the radiographic system disclosed in the specification, a driving voltage of the radiological image detector in the second mode may be higher than that of the radiological image detector in the first mode.

Also, the radiographic system disclosed in the specification may further include a calculation processing unit that calculates a refraction angle distribution of the radiation incident onto the radiological image detector, from a plurality of image data acquired by the radiological image detector in the first mode, and generates a phase contrast image, based on the refraction angle distribution.

Also, the radiographic system disclosed in the specification may further include a correction unit that performs an offset correction for each of the plurality of image data acquired by the radiological image detector in the first mode, and the correction unit performs the offset correction for each of the plurality of image data, based on common data for correction.

Also, according to the radiographic system disclosed in the specification, the calculation processing unit may generate an absorption image from the plurality of image data that is offset-corrected by the correction unit.

What is claimed is:

1. A radiographic system comprising:
a first grating;
a second grating having a period that substantially coincides with a pattern period of a radiological image formed by radiation having passed through the first grating;
a radiological image detector that detects the radiological image masked by the second grating and outputs image data of the detected radiological image; and
a control unit that performs a switching between a first mode in which a plurality of imaging is performed with the second grating being positioned at relative positions having different phases with regard to the radiological image and a second mode in which the radiological image detector is driven without radiation exposure,
wherein the control unit repeatedly drives the radiological image detector in the second mode until the radiological image detector is in a steady state and shifts to the first mode after the radiological image detector is in the steady state.

2. The radiographic system according to claim 1, wherein
the control unit determines whether the radiological image detector is in the steady state, based on a temperature of an output circuit unit of the radiological image detector that outputs the image data.

3. The radiographic system according to claim 2, wherein
the control unit determines that the radiological image detector is in the steady state when a temperature difference of the output circuit unit before and after the radiological image detector is driven is a preset threshold or smaller.

4. The radiographic system according to claim 1, wherein
the control unit determines whether the radiological image detector is in the steady state, based on signal values of one or more pixels configuring the image data.

5. The radiographic system according to claim 4, wherein
the control unit determines that the radiological image detector is in the steady state when a variation ratio of the signal values of the one or more pixels is a preset threshold or smaller.

6. The radiographic system according to claim 1, wherein
a driving frequency of the radiological image detector in the second mode is higher than that of the radiological image detector in the first mode.

7. The radiographic system according to claim 1, wherein
a driving voltage of the radiological image detector in the second mode is higher than that of the radiological image detector in the first mode.

8. The radiographic system according to claim 1, further comprising:
a calculation processing unit that calculates a refraction angle distribution of the radiation incident onto the radiological image detector, from a plurality of image data acquired by the radiological image detector in the first mode, and generates a phase contrast image, based on the refraction angle distribution.

9. The radiographic system according to claim 8, further comprising:
a correction unit that performs an offset correction for each of the plurality of image data acquired by the radiological image detector in the first mode,
wherein the correction unit performs the offset correction for each of the plurality of image data, based on common data for correction.

10. The radiographic system according to claims 9, wherein
the calculation processing unit generates an absorption image from the plurality of image data that is offset-corrected by the correction unit.
